(19) United States
(12) Patent Application Publication
(10) Pub. No.: US 2021/0282429 A1
(43) Pub. Date: Sep. 16, 2021

(54) Vegetable crop alternative protein product

(71) Applicant: Michelle Angela Samuel, Bowie, MD (US)

(72) Inventor: Michelle Angela Samuel, Bowie, MD (US)

(21) Appl. No.: 16/816,209

(22) Filed: Mar. 11, 2020

(30) Foreign Application Priority Data
Mar. 11, 2020 (TT) 16816209

(51) Int. Cl. A23J 3/14; A23J 1/00; A23J 3/22

(52) U.S. Cl. CPC A23J 3/14; A23J 3/227; A23J 1/006

(57) ABSTRACT

An unmodified, undenatured whole plant-based protein burger alternative is provided for vegans and vegetarians. Yardlong bean is combined with 3 whole plant-based aromatic ingredients and flour to form a ‘sticky’ homogenous mixture. The composition is subjected to low heat to retain nutrients and activate organic binders. The product succeeds in achieving superior sensory flavors and aroma, a chewy vegetable specific texture, and an aesthetic appearance of beef patties. It is a whole plant-based food alternative to highly complex processed foods. This product is naturally paleo, low carb, ketogenic, diabetic- and environmental-friendly.

### REFERENCES CITED

### US Patent Documents

2001/00443974 A1 11/2001 Linford et al.

2015/10477882 B1 04/2015 Wang

2019/10172380 B2 01/2019 Varadan et al.

### BACKGROUND

The debates are all over social media. There are a high percentage of vegans that do not desire meat substitutes that simulate the taste, texture and appearance of traditional meat—they beg to question “Why would vegans want their food to look like meat?” Vegans do not consume animal protein or animal-based products for health reasons, environmental concerns and food sustainability. There is a growing movement towards whole plant-based food consumption for increased concerns ranging from animal rights and protection to food safety, health, nutrition, and climate change. As a result, there is a demand for simpler processed whole plant-based food (WPBF) products, but at the same time for more variety on the market. This invention takes nutritional factors into account. An innovative approach is used to create a plant-based protein-replacement product by looking towards a little-known vegetable crop, while using less processes and less heat to provide more health benefits.

### SUMMARY

### Problem to be Solved by the Invention

It is the objective of the present invention to make better use of vegetable crop proteins throughout the food chain. It is the objective of the present invention to submit a meatless protein WPBF product. It is the objective of the present invention to provide an unmodified, undenatured vegetable-based protein product with a plant specific texture. It is also the objective of this invention to provide a meatless product that is easily digested and assimilated by the body with no adverse side effects. It is therefore appropriate to use this highly nutritious whole plant product as part of a plant-based diet to help prevent and reverse chronic illnesses and diseases such as kidney disease, lupus, diabetes, multi-sclerosis heart and disease (#1 killer).

The present invention consists of no artificial ingredients, no preservatives, and no processed or GMO products.

Traditionally, soybeans, soy-based and dried bean legume as opposed to vegetable crop protein ingredients have been used to make substitute meat-less food products. Most recently alternative diet products have turned to more modified ingredients such as soy protein isolate, pea protein isolate, rice protein and mung bean protein as protein substitutes to make faux meat products aimed to replicate meat-like taste, texture and appearance. This approach has created a certain degree of dissension among the vegan community. It has further isolated those with preferences towards unmodified WPBF products leaving them with less options.

This invention arose out of a desire for non-GMO, non-modified, vegan meatless protein replacement food products. The desire was first explored from a novel idea to experiment with a little-known vegetable crop protein to create a vegan plant-based protein alternative.

This invention sets forth the use of a non-obvious ingredient—yardlong bean—Vigna unguiculata (L.) Walp. ssp. sesquipedalis (L.) Verdc., plant symbol=VIUNS2 to make a vegan burger patty. The plant is subtropical/tropical and is widely cultivated in the warmer parts of South Asia, Southeast Asia, and southern China. It is classified as a vegetable crop. It is typically used to make a variety of dishes and is mostly steamed, stir-fried or curried. It is a good source carbohydrates and protein; a serving of 100 grams of yardlong beans contains 8 g of total carbohydrates (2% daily value), and 3 g of protein (5% daily value).

This invention introduces a vegetable crop product that is a non-GMO, non-soy or non-pea isolate vegan protein, utilizing conservative processes to allow for the development of an undenatured whole plant-based protein substitute burger product. The procedure consists of: i) the use of yardlong bean, an unknown alternative plant protein with a plant-specific texture; ii) the use of organic unbleached flour, as a binding agent; iii) the use of organic fresh whole plant-based aromatics for flavor appeal and; iv) the use of fats to fry the product. A new unprocessed whole plant-based protein product is developed:

i) The role of Yardlong Bean

Yardlong bean is an Asian legume that has been used in Asia to make certain dishes. To this date, it is used in Asia and certain parts of the Caribbean to make vegetarian foods, but it is largely unknown outside of Asia. In this invention, yardlong bean is used as a source of plant protein in a novel process. The role is threefold: a replacement source of an unmodified plant-based protein for protein isolate products that are often either GMO or denatured; its organic binding properties; and its chewy texture. Yardlong bean also provides vitamin A, thiamin, riboflavin, iron, phosphorus, and potassium, and is a very good source for vitamin C, folate, magnesium, and manganese, which contributes to the added overall nutritional value of the end-product.

From a protein nutritional standpoint, yardlong bean may be combined with a high protein vegetable to increase the overall protein concentration of the final product in accordance with the present invention. The inventor considered optimizing with another non-obvious ingredient, Amaranth. Amaranth has a high protein content, ranging from 14.5 to 17.8% due to high amounts of lysine- and sulfur-containing amino acids (Gorinstein etal., 2002). However, the mixture of the amaranth and the yardlong bean did not bind well without losing cohesiveness of the overall mixture and fell apart. Further research and development are required in this preferred implementation.

ii) The Role of Organic Unbleached, non-GMO Flour

The flour performs as a binder in conjunction with the organic binders of the yardlong bean to bind and form a uniform cohesive mixture.

iii) The Role of Aromatics

A combination of whole plant aromatic ingredients is used to enhance flavor and taste. A low heat process allows the flavor to be taken-up by the base ingredient which results in a unique taste that surpasses all the sensory features of meat.

iv) The Role of Fat

The fat is used for frying and for moisture content. The patty turns from green-to-brown while frying which provides an aesthetic appearance quality similar to that of a more traditional burger patty.

### BRIEF DESCRIPTION OF THE DRAWINGS

For a more complete understanding of the present invention, and further advantages thereof, reference is now made to the following figures, photograph and detailed description:

FIG. 1 is a process flow diagram for making yardlong plant-based protein alternative burger patty in accordance with the present invention;

FIG. 2 is a schematic diagram of the manufacturing production of yardlong plant-based protein alternative burger patty product in accordance with the present invention and;

FIG. 3 is a profile view photograph of the yardlong burger plant-based protein alternative assembly in accordance with the present invention.

### DETAILED DESCRIPTION OF THE INVENTION

The present invention sets forth an alternative protein-based vegetable crop product with high nutrients, fiber and protein content, that can be shaped into a patty with an unanticipated chewy vegetable specific texture, superior taste, that is made without GMO ingredients. The yardlong bean is used as the raw ingredient in the present invention. This green bean is classified as a vegetable crop and it is distinguished from many other legumes and pluses already used for making burger patties. The entire vegetable including the enclosing the pods is utilized. It will be appreciated that other products can be derived using other vegetable crop varieties and alternative methods in accordance with this invention. Variety crops such as runner bean (Phaseolus coccineus) and hyacinth bean (Lablab purpureus) or a combination of vegetable crops can be used to make similar products. The description below illustrates the principles of the invention.

Yardlong Bean Product:

There are many replicated meat products that have been made by forming texturized vegetable protein (mostly grain or legume) and isolates. Such products use soy and pea protein mixed with plant-flour in a mechanical extrusion process to obtain a meat-like texture when they are rehydrated and cooked. The problem with these products is that they are highly processed, and the proteins are modified—even though soy, for instance, is considered a nutritious food that contains the eight essential amino acids that are required for human nutrition. But, depending on the process used, it is a well-known fact that key nutrients in vegetables are significantly reduced when subjected to heat. Therefore, slow cooking times and low temperatures are highly recommended when processing plant-based ingredients. This invention takes nutritional factors into account and so less processing and less heat is used to provide a healthier product.

The Process and Procedure:

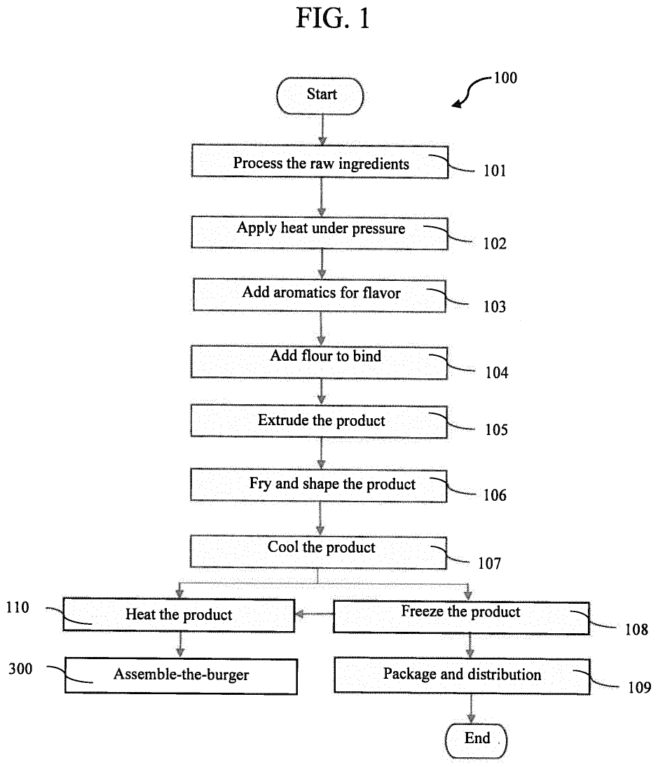

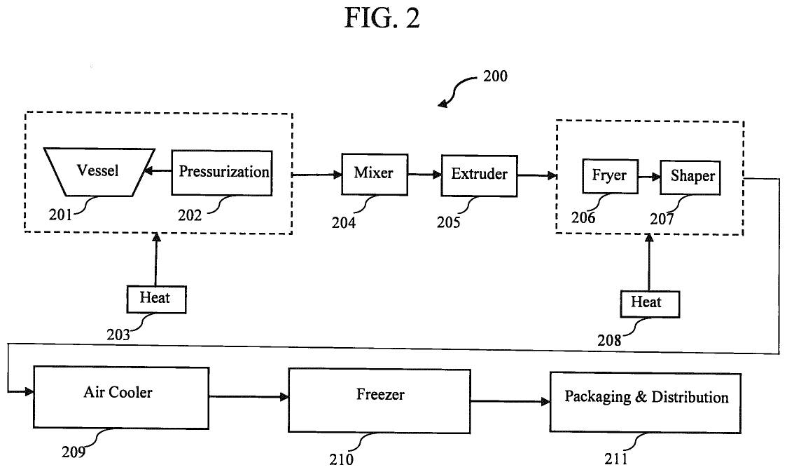

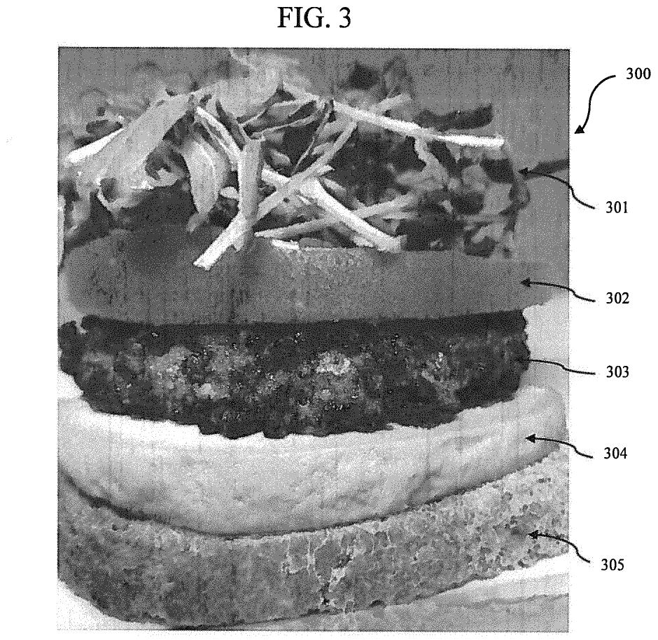

Reference is made to the process flow diagram (100) as shown in FIG. 1; the manufacturing process as illustrated in FIG. 2; and a profile view is illustrated in FIG. 3 of the final product in associated with the invention.

A low heat process is preferred for the preservation of naturally found nutrients, protein and minerals in the vegetable crop.

1. Preparation of Vegetable Ingredients:

The first step involves mechanically processing the fresh raw ingredients (101) by using a food processor (HAMILTON BEACH 12-Cup Stack & Snap™ Food Processor with Big Mouth, Black & Stainless MODEL: 70725) with the S-Blade. The vegetable is processed on the chop setting to yield pieces of 1-3 mm in length.

2. Blanching:

The finely chopped yardlong bean vegetable is blanched at 248 deg F for no more than approximately 1-2 minutes. The liquid to solids ratio is approximately 1 part of water to 50 parts of solids. This step is performed in order to breakdown the fibers and improve digestibility. This pre-conditioning step (102) is also conducted to activate organic binders and initiate settings for texturization in the final product. The time, temperature and volume of water would vary depending on the mass of the mixture. It was discovered that the texture of the final product is a function of time and temperature.

3. Seasoning:

Fresh whole plant herbal aromatics are processed 101 and are added to evenly distribute the flavor (103) in the mixture. The internal heat from process 102 is utilized by using heat transfer—the flavor of the herbs is released as it is taken up by the yardlong bean mixture. The seasoning is added in 1:1 ratio by mass of the total composition.

4. Binding

Organic flour is used as a binder; it is added to the mixture (104) in a ratio of approximately 1-2% by weight of the total wet mixture. The composition is well mixed 104 until a homogenous “sticky” consistency is formed.

5. Extruding

The mixture is loaded on a patty molding press (105) machine (Eurodib HF100 Manual Hamburger Patty Molding Press with Single-Level Press Handle) as a portion control mechanism. The mold unit 105 ensures that each patty is precisely 102 mm in diameter and 57 g in weight. No heat or pressure treatment are required in the process.

6. Shaping and Frying

The patty is fried in a preheated pan-fryer (106) at 332-345 deg F in refined oils such as peanut oil or sunflower oil. These temperatures are necessary to create a crust on the patty as soon as it hits the fryer. This seals the outsides, preventing the insides from absorbing too much oil. Additionally, these oils are preferred because they have a much higher smoke point of almost 500 deg F and can withstand higher temperatures without releasing harmful compounds, including carcinogenic, cancer-causing free radicals. The patty is shaped as it is fried 106 for about 4-5 minutes while flipping every 2 mins until it turns from green-to-brown. The cooked patties have the appearance of a beef patty but with superior flavor and aroma to conventional meat.

7. Cooling and Freezing

The cooked patties are placed on a cooling rack (107). The patties could either be used right away or could be frozen until ready to be eaten. The long product shelf life of the cooked patty is achieved without the use of artificial preservatives. The taste remained intact by freezing (108).

8. Packing

The frozen product is packed (109) in a sealed container, stored and shipped. The product is held in a frozen state until ready to be eaten. When ready to be eaten, the patty is removed from the freezer and placed directly into a preheated oven (110) until heated to an internal temperature of 160 deg F. This step is critical in restoring the patty to its original state as when it was freshly made.

The Manufacturing Process:

Reference is made to the schematic diagram shown in FIG. 2 illustrating the layout of the manufacturing production (200) in accordance with the invention. A food processor unit which is not shown is used to chop the yardlong bean. A chamber (201) with time, temperature (203) and pressure (202) controls is used to perform the preprocessing step. Mixing is conducted by using a food paddle mixer (204) and then the mixture is received by an extruder (205). A pan-fryer (206) with temperature (208) controls is used to cook the extruded portions. The patty is shaped (207) while frying 206. Cooling racks (209) are used to allow the patties to cool at room temperature, before putting to freeze (210). Depending on the facility the product could be packaged before it is frozen until time for shipment and distribution.

The Burger Assembly:

FIG. 3 illustrates an example of an assembled yardlong (300) plant-based protein alternative WPBF product in accordance with the invention. The plant-based burger patty (303) is paired with whole grain+flax bread (305) from local artisan baker Atwater's. It is layered with a slice of avocado (304), followed by a patty 303. On top of the patty 303 is a thick juicy slice of heirloom tomato (302), and it's nutritiously balanced with a generous serving of alfalfa or pea shoot sprouts (301). As an option, a layer of melted plant-based cheese could be added for a more traditional style burger.

What is claimed:

1. A method of preparing a vegetable crop protein substitute food product comprising of the following steps: blanch the yardlong bean vegetable for about 1-2 mins, wherein it was discovered that it acts as a natural bio-adhesive; add equal parts of plant-based aromatics in a 1:1 ratio to the base ingredient; add flour at a 1-2% by weight of the total wet mixture, wherein the flour and water content in the mixture forms a liquid glue which acts in conjunction with the organic binders of the yardlong bean and serves as an adhesive to the other ingredients; extrude, fry and shape the mixture to form a whole plant-based food patty.

2. The method of claim 1, wherein the yardlong bean is not widely known, and it is the first time the vegetable crop protein is utilized to make a burger patty. It offers variety to the marketplace and brings awareness about making better use of the wider food chain in support of food sustainability.

3. The method of claim 1, wherein the mixture is pan-fried at 332-345 deg F for a time period of 4-5 minutes and the color changes from green-to-brown.

4. The method of claim 1, wherein it is a continuous process from start to end and the mixture should not stand beyond 20-30 mins before frying once all ingredients are combined.

5. The method of claim 1, wherein the thickness of the patty is not limiting; due to the natural adhesive properties of the yardlong bean thin patties could be made without falling apart.

6. The method of claim 1, wherein the process is simple, there is no killing of nutrients, no-e-coli, no-slaughterhouse or torture involved.

7. The method of claim 1, wherein the final product is 100% whole plant-based food and contains no chemically synthesized ingredients, no artificial ingredients, no preservatives and no processed or GMO products.

8. The method of claim 1, wherein long shelf life is attained; the original taste, texture and freshness are restored once the frozen patty is reheated straight from the freezer unto a preheated oven or grill. No artificial preservatives are required.
